(19) United States
(12) Patent Application Publication
(10) Pub. No.: US 2007/0005162 A1
(43) Pub. Date: Jan. 4, 2007

(54) Lighting audio playing apparatus

(76) Inventors: Keith Chiang, Jhonghe City (TW); Chao-Chi Huang, Jhonghe City (TW)

Correspondence Address: TROXELL LAW OFFICE, SUITE 1404, 5205 LEESBURG PIKE, FALLS CHURCH, VA, 22041, US

(21) Appl. No.: 11/180,529

(22) Filed: Jul. 14, 2005

(30) Foreign Application Priority Data
Jun. 30, 2005 (TW) 094210986

(51) Int. Cl. G06F 17/00

(52) U.S. Cl. 700/94

(57) ABSTRACT

A lighting audio playing apparatus comprising: a printed circuit board, for bearing the following elements; a connector, disposed on the printed circuit board for being coupled to a portable storage device; a playing controller, coupled to the connector; an audio decode controller, coupled to the playing controller; at least one lighting device, coupled to the playing controller; an audio output device, coupled to the audio decode controller; and at least one function key, coupled to the playing controller; whereby while the portable storage device being inserted into the connector, the playing controller will check whether a compressed audio file stored therein or not, if there exists a compressed audio file, the playing controller will transfer the compressed audio file to the audio decode controller to decompress it then output, meanwhile, the playing controller will drive the lighting device to light various color lights.

### BACKGROUND OF THE INVENTION

1. Field of the Invention

The present invention relates to a lighting audio playing apparatus, and particularly the present invention relates to a lighting audio playing apparatus when a portable storage device contained compressed audio file being inserted into the connector, the lighting audio playing apparatus will automatically decompress and play the audio file, meanwhile, the lighting device will light various color lights according to the compressed audio file.

2. Description of Related Art

Generally speaking, the portable storage device, such as portable flash memory device with USB interface (that is so-called thumb storage device) generally has 64 MB-1 GB storage capacity, it has easy carrying and using advantages, therefore, the portable flash memory device is popularly welcomed by the user after it is promoted. However, accompanying the portable electronic device, such as digital camera providing more appropriate price and higher pixel resolution, user generally needs to use high capacity portable flash memory device to store image data; therefore, old or low capacity portable flash memory device will be left unused, such is very pitiful.

Furthermore, the MP3 players presented in the market generally only focused on their appearances and color, they generally had a power indicator for indicating its working status, so the light varying was ignored when the MP3 player played music, therefore, the appearance of the MP3 player was monotonous when the MP3 player played music.

There is therefore a need for a new and improved strategy and technique for overcoming these deficiencies and the present invention overcomes these deficiencies in a new and novel fashion.

### SUMMARY OF THE INVENTION

The present invention generally relates to a strategy and a technique which overcomes some or all of the above referenced deficiencies associated with prior art MP3 player.

It is a first non-limited object of the present invention is to provide a lighting audio playing apparatus which comprises a connector for providing a portable storage device being inserted into, when the portable storage device contained compressed audio file being inserted into the connector, the lighting audio playing apparatus will automatically decompress and play the audio file, meanwhile, the lighting device will light various color lights according to the compressed audio file.

It is a second non-limited object of the present invention is to provide a lighting audio playing apparatus which comprises a display device for display time.

According to a first non-limited object of the present invention, a lighting audio playing apparatus comprises: a printed circuit board, for bearing the following elements; a connector, disposed on the printed circuit board for being coupled to a portable storage device; a playing controller, coupled to the connector; an audio decode controller, coupled to the playing controller; at least one lighting device, coupled to the playing controller; an audio output device, coupled to the audio decode controller; and at least one function key, coupled to the playing controller; whereby while the portable storage device being inserted into the connector, the playing controller will check whether a compressed audio file stored therein or not, if there exists a compressed audio file, the playing controller will transfer the compressed audio file to the audio decode controller to decompress it then output, meanwhile, the playing controller will drive the lighting device to light various color lights.

### BRIEF DESCRIPTION OF THE DRAWINGS

The present invention can be more fully understood by referring to the following description and accompanying drawings, in which:

FIG. 1 is the block diagram of the lighting audio playing apparatus according to one preferred. embodiment of the present invention.

FIG. 2 is the prospective view which shows the lighting audio playing apparatus 1 further comprises a housing 30 according to one preferred embodiment of the present invention.

FIG. 3 is the prospective view which shows the lighting audio playing apparatus 1 further comprises an egg-shaped housing 30 according to one preferred embodiment of the present invention.

FIG. 4 is the prospective view which shows the lighting audio playing apparatus 1 further comprises a square-shaped housing 30 according to one preferred embodiment of the present invention.

FIG. 5 is the prospective view which shows the lighting audio playing apparatus 1 further comprises a triangle-shaped housing 30 according to one preferred embodiment of the present invention.

FIG. 6 is the prospective view which shows the lighting audio playing apparatus 1 further comprises a mushroom-shaped housing 30 according to one preferred embodiment of the present invention.

FIG. 7 is the prospective view which shows the lighting audio playing apparatus 1 further comprises an egg-shaped housing 30 and a display device 23 according to one preferred embodiment of the present invention.

### DETAILED DESCRIPTION OF THE PREFERRED EMBODIMENTS

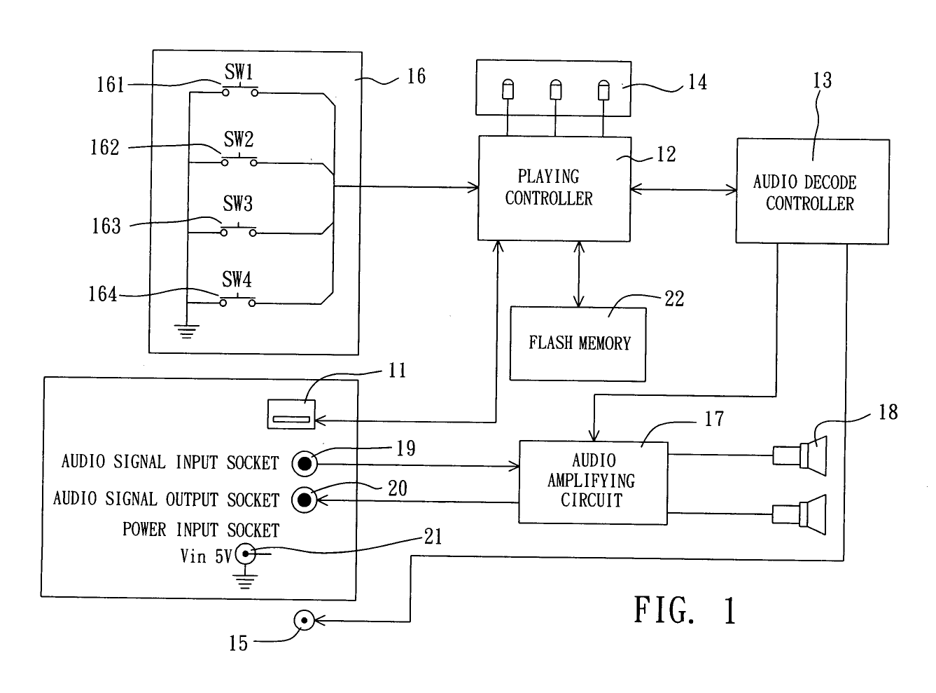

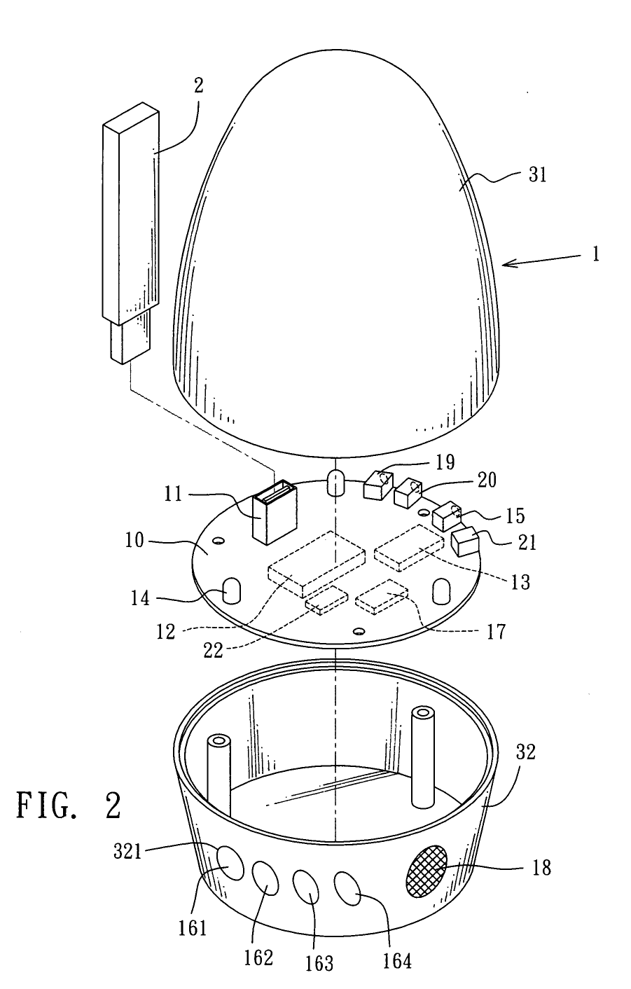

Please refer to FIG. 1, which shows the block diagram of the lighting audio playing apparatus according to one preferred embodiment of the present invention. As shown in FIG. 1, the lighting audio playing apparatus 1 of the present invention comprises: a printed circuit board 10; a connector 11; a playing controller 12; an audio decode controller 13; at least one lighting device 14; an audio output device 15; and at least one function key 16.

Wherein, the printed circuit board 10 (please refer to FIG. 2), for bearing the connector 11, playing controller 12, audio decode controller 13, at least one lighting device 14, audio output device 15 and at least one function key 16.

The connector 11 is for example but not limited to a USB interface socket and disposed on the printed circuit board 10 for providing a portable storage device 2 (please refer to FIG. 2) being inserted therein.

The playing controller 12 is coupled to the connector 11, it further comprises a USB On-To-Go (OTG) module (figure not shown) for proceeding a connecting process between the lighting audio playing apparatus 1 and the portable storage device 2. In the USB system structure, a computer host or a master device of previous unit is the master end of the USB system, all USB bus signals must be issued from the computer host. Therefore, while two USB slave devices, such as the lighting audio playing apparatus 1 of the present invention and the portable storage device 2 are connected each other, neither of them can act as the master end, therefore, the two USB slave devices can not work properly in such connection environment; for solving the aforesaid problem, the USB-IF announced the USB OTG specification to recover the drawback of the older version USB specification. The USB OTG is an abbreviation of the “USB On-The-GO”, such USB OTG specification has an advantage similar to the point-to-point of the IEEE 1394 fireware. According to the point-to-point advantage, one USB slave device can read file(s) in another USB slave device without through a computer host. Therefore, the lighting audio playing apparatus 1 of the present invention can access the file(s) or data in the portable storage device 2 by using the USB On-To-Go module of the playing controller 12.

The audio decode controller 13 is for example but not limited to a MP3 or MP4 audio decode controller and coupled to the playing controller 12, it can decompress the audio compressed file(s) stored in the portable storage device 2.

The lighting device 14 is coupled to the playing controller 12, wherein the lighting device 14 of the present invention is for example but not limited to a multi-color LED, and the amount of the lighting device 14 is three, the playing controller 12 can control the lighting device 14 to emit various colors corresponding to the audio compressed file(s).

The audio decode controller 15 is for example but not limited to a earphone socket and coupled to the playing controller 14, for providing an external speaker (figure not shown) with amplifying circuit being plugged therein so as to output the decompressed audio signal. Furthermore, for getting better sound effect, the playing apparatus 1 of the present invention further comprises an audio amplifying circuit 17 and a speaker 18, wherein, the amplifying circuit 17 is coupled between the audio decode controller 13 and the audio output device 15, for amplifying the decompressed audio signal then outputting through the speaker 18.

The function keys 16 are coupled to the playing controller 12, wherein, the amount of the function keys 16 are four, there are Power/Play/Pause key 161, Vol+/Next key 162, Vol−/Prev key 163 and Sequence/Random/Repeat key 164, respectively four, there are Power/Play/Pause key, Vol+/Next key, Vol−/Previous key and Sequence/Random/Repeat one key 164, respectively. Wherein, the Power/Play/Pause key 161 can enable user to control the Power/Play/Pause action of the playing apparatus 1; the Vol+/Next key 162 can enable user to upward control the volume or select next song to listen; the Vol−/Prev key 163 can enable user to downward control the volume or select previous song to listen; and the Sequence/Random/Repeat key 164 can enable user to control the Sequence/Random/Repeat one action of the playing apparatus 1.

Furthermore, the playing apparatus 1 of the present invention further comprises an audio signal input socket (Audio IN) 19, an audio signal output socket (Audio OUT) 20, a power input socket (DC JACK) 21 and a flash memory 22, wherein, the audio signal input socket 19 is provided for inputting an audio signal to the audio amplifying circuit 17 then outputting through the audio output device 18; the audio signal output socket 20 is coupled to the audio amplifying circuit 17 for amplifying the decompressed audio signal then outputting; the power input socket 21 is provided for a power adapter (figure not shown) being inserted therein for inputting a DC power to the lighting audio playing apparatus; while the flash memory 22 is coupled to the playing controller 12 for storing the compressed audio file(s).

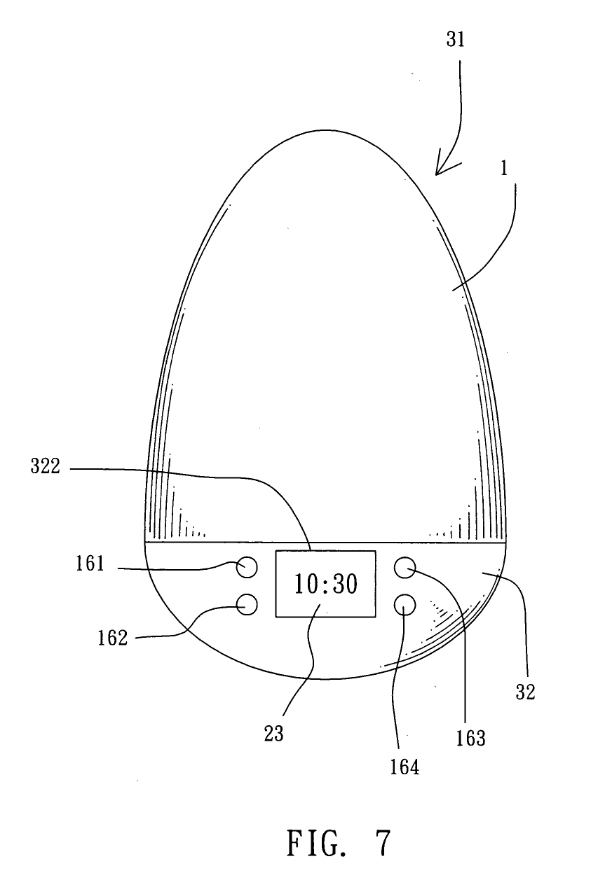

Please refer to FIG. 2, which shows the lighting audio playing apparatus 1 further comprises a housing 30 according to one preferred embodiment of the present invention. As shown in FIG. 2, the lighting audio playing apparatus 1 of the present invention further comprises a housing 30, wherein, the housing 30 has an egg-shaped, square-shaped, mushroom-shaped or triangle-shaped appearance. The housing 30 further comprises an upper housing 31 and a lower housing 32, wherein, the upper housing 31 and the lower housing 32 can be mutually engaged; wherein, the lower housing 32 comprises a plurality of holes 321 for providing the Power/Play/Pause key 161, Vol+/Next key 162, Vol−/Prev key 163 and Sequence/Random/Repeat key 164 exposed outward; the printed circuit board 10 is disposed in the lower housing 32, and the upper housing 31 is made of transparent or semi-transparent material such that the various lights emitted by the lighting device 14 can pass through the upper housing 31. Furthermore, the lighting audio playing apparatus 1 of the present invention further comprises a display device 23 (please refer to FIG. 7) exposed outside the lower housing 32 for display time, wherein, the display device 23 is a LCD or a seven segment LED, preferably.

While using the lighting audio playing apparatus 1 of the present invention, user can insert a portable storage device 2 into the connector 11, then the USB OTG module of the playing controller 12 will automatically check whether a compressed audio file (or more compressed audio files) stored therein or not, if the compressed audio file is stored in the portable storage device 2, the playing controller 12 will transfer the compressed audio file to the audio decode controller 13 to decompress it and amplify it by the audio amplifying circuit 17 then output through the speaker 18, meanwhile, the playing controller 12 will drive the lighting device 14 to light various color lights. Therefore, the lighting audio playing apparatus 1 of the present invention can exactly overcome the drawbacks of the aforesaid prior art portable MP3 players.

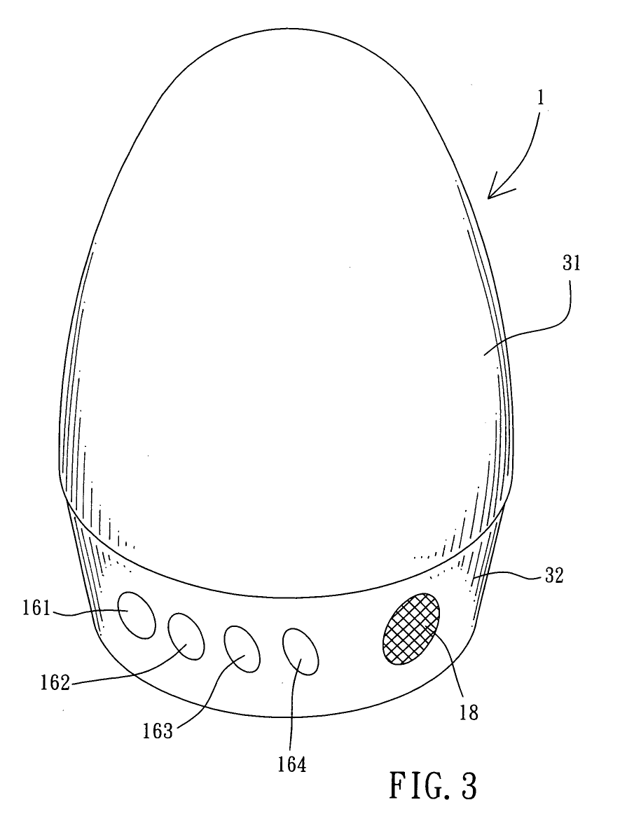

Please refer to FIG. 3, which shows the lighting audio playing apparatus 1 further comprises an egg-shaped housing 30 according to one preferred embodiment of the present invention. As shown in FIG. 3, the lighting audio playing apparatus 1 of the present invention comprises an egg-shaped housing 30, wherein, its upper housing 31 is made of transparent or semi-transparent material such that the various lights emitted by the lighting device 14 can pass through the upper housing 31, and the lower housing 32 comprises Power/Play/Pause key 161, Vol+/Next key 162, Vol−/Prev key 163 and Sequence/Random/Repeat key 164 exposed form the holes 321 for providing the user to operate the lighting audio playing apparatus 1.

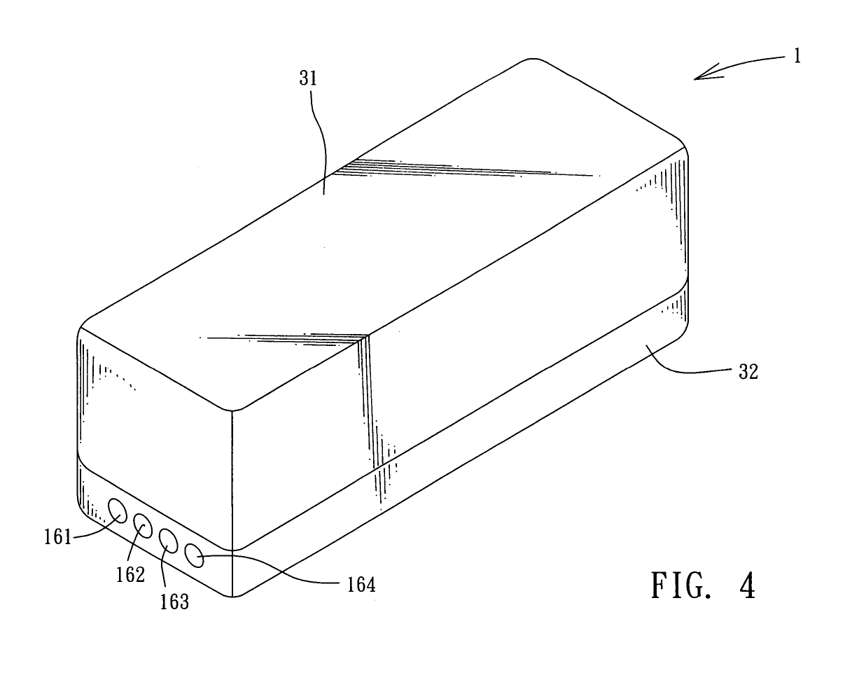

Please refer to FIG. 4, which shows the lighting audio playing apparatus 1 further comprises a square-shaped housing 30 according to one preferred embodiment of the present invention. As shown in FIG. 4, the lighting audio playing apparatus 1 of the present invention comprises a square-shaped housing 30, wherein, its upper housing 31 is made of transparent or semi-transparent material such that the various lights emitted by the lighting device 14 can pass through the upper housing 31, and the lower housing 32 comprises Power/Play/Pause key 161, Vol+/Next key 162, Vol−/Prev key 163 and Sequence/Random/Repeat key 164 exposed form the holes 321 for providing the user to operate the lighting audio playing apparatus 1.

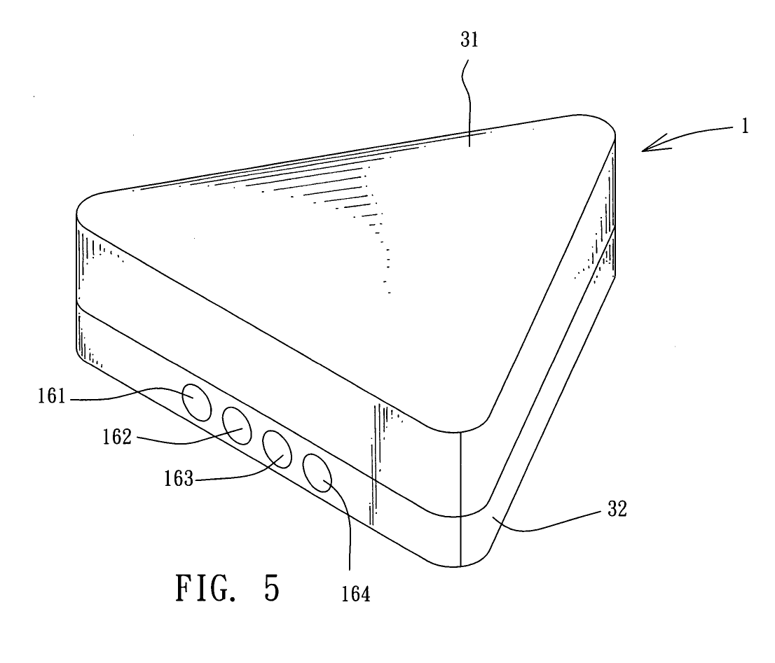

Please refer to FIG. 5, which shows the lighting audio playing apparatus 1 further comprises a triangle-shaped housing 30 according to one preferred embodiment of the present invention. As shown in FIG. 5, the lighting audio playing apparatus 1 of the present invention comprises a triangle-shaped housing 30, wherein, its upper housing 31 is made of transparent or semi-transparent material such that the various lights emitted by the lighting device 14 can pass through the upper housing 31, and the lower housing 32 comprises Power/Play/Pause key 161, Vol+/Next key 162, Vol−/Prev key 163 and Sequence/Random/Repeat key 164 exposed form the holes 321 for providing the user to operate the lighting audio playing apparatus 1.

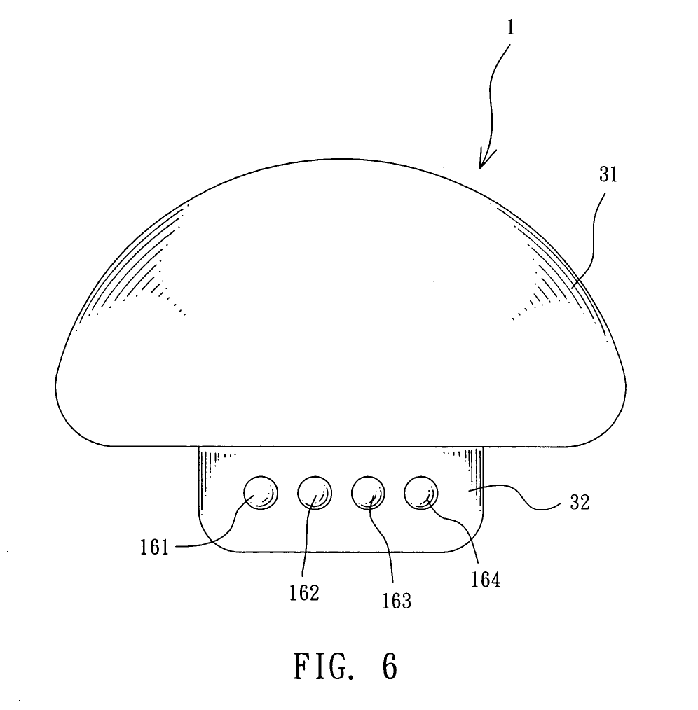

Please refer to FIG. 6, which shows the lighting audio playing apparatus 1 further comprises a mushroom-shaped housing 30 according to one preferred embodiment of the present invention. As shown in FIG. 6, the lighting audio playing apparatus 1 of the present invention comprises a mushroom-shaped housing 30, wherein, its upper housing 31 is made of transparent or semi-transparent material such that the various lights emitted by the lighting device 14 can pass through the upper housing 31, and the lower housing 32 comprises Power/Play/Pause key 161, Vol+/Next key 162, Vol−/Prev key 163 and Sequence/Random/Repeat key 164 exposed form the holes 321 for providing the user to operate the lighting audio playing apparatus 1.

Please refer to FIG. 7, which shows the lighting audio playing apparatus 1 further comprises an egg-shaped housing 30 and a display device 23 according to one preferred embodiment of the present invention. As shown in FIG. 7, the lighting audio playing apparatus 1 of the present invention comprises an egg-shaped housing 30, wherein, its upper housing 31 is made of transparent or semi-transparent material such that the various lights emitted by the lighting device 14 can pass through the upper housing 31, and the lower housing 32 comprises Power/Play/Pause key 161, Vol+/Next key 162, Vol−/Prev key 163 and Sequence/Random/Repeat key 164 exposed form the holes 321 for providing the user to operate the lighting audio playing apparatus 1. Furthermore, the lower housing 32 further comprises an opening 322 for providing the display device 23 exposed, thus, the lighting audio playing apparatus 1 of the present invention not only has the ability of lighting various color lights according to the decompressed audio file(s), but also has the ability of showing time.

While the invention has been described with reference to preferred embodiment thereof, it is to be understood that modifications or variations may be easily made without departing from the spirit of this invention, which is defined by the appended claims.

What is claimed is:

1. A lighting audio playing apparatus comprising:
a printed circuit board, for bearing the following elements;
a connector, disposed on said printed circuit board for being coupled to a portable storage device;
a playing controller, coupled to said connector;
an audio decode controller, coupled to said playing controller;
at least one lighting device, coupled to said playing controller;
an audio output device, coupled to said audio decode controller; and
at least one function key, coupled to said playing controller;
whereby while said portable storage device being inserted into said connector, said playing controller will check whether a compressed audio file stored therein or not, if there exists a compressed audio file, said playing controller will transfer said compressed audio file to said audio decode controller to decompress it then output, meanwhile, said playing controller will drive said lighting device to light various color lights.

2. The lighting audio playing apparatus as claimed in claim 1, wherein said connector is a USB interface socket.

3. The lighting audio playing apparatus as claimed in claim 1, wherein said playing controller further comprises a USB On-To-Go module, for proceeding a connecting between said lighting audio playing apparatus and said portable storage device.

4. The lighting audio playing apparatus as claimed in claim 1, wherein said audio decode controller is a MP3 or MP4 audio decode controller.

5. The lighting audio playing apparatus as claimed in claim 1, wherein said lighting device is a multi-color LED, and the amount of said lighting device is three.

6. The lighting audio playing apparatus as claimed in claim 1, wherein the amount of said function key is four, there are Power/Play/Pause key, Vol+/Next key, Vol−/Previous key and Sequence/Random/Repeat one key, respectively.

7. The lighting audio playing apparatus as claimed in claim 1, wherein it further comprises a flash memory coupled to said playing controller for storing said compressed audio file.

8. The lighting audio playing apparatus as claimed in claim 1, wherein it further comprises an audio amplifying circuit coupled between said audio decode controller and said audio output device, for amplifying said decompressed audio signal then outputting, wherein said audio output device is an earphone socket or a speaker.

9. The lighting audio playing apparatus as claimed in claim 8, wherein it further comprises an audio signal input socket, an audio signal output socket and a power input socket, wherein, said audio signal input socket is provided for inputting an audio signal to said audio amplifying circuit then outputting through said audio output device; said audio signal output socket is coupled to said audio amplifying circuit for amplifying said decompressed audio signal then outputting; while said power input socket is provided for a power adapter being inserted therein for inputting a DC power to said lighting audio playing apparatus.

10. The lighting audio playing apparatus as claimed in claim 1, wherein it further comprises a housing, said housing further comprises an upper housing and a lower housing, wherein, said upper housing and said lower housing can be mutually engaged; wherein, said printed circuit board is disposed in said lower housing, and said upper housing is made of transparent or semi-transparent material such that said various lights emitted by said lighting device can pass through said upper housing.

11. The lighting audio playing apparatus as claimed in claim 10, wherein it further comprises a display device exposed outside said lower housing for display time.

12. The lighting audio playing apparatus as claimed in claim 11, wherein said display device is a LCD or a seven segment LED.

13. The lighting audio playing apparatus as claimed in claim 10, wherein said housing has an egg-shaped, a square-shaped, a mushroom-shaped or a triangle-shaped appearance.
